(19) United States
(12) Patent Application Publication
(10) Pub. No.: US 2005/0155990 A1
(43) Pub. Date: Jul. 21, 2005

(54) Liquid dispenser

(76) Inventor: Ryan Alexander Gardiner, Toronto (CA)

Correspondence Address: MANELLI DENISON & SELTER, 2000 M STREET NW SUITE 700, WASHINGTON, DC, 20036-3307, US

(21) Appl. No.: 11/037,216

(22) Filed: Jan. 19, 2005

(30) Foreign Application Priority Data
Jan. 21, 2004 (CA) 2,455,834

(51) Int. Cl. B67D 5/60

(52) U.S. Cl. 222/464.7; 222/320

(57) ABSTRACT

A liquid dispenser comprising (a) a container for holding a dispensable liquid and having (i) a base with a base inner surface and (ii) an upstanding container side; (b) inner conduit means having a conduit lower aperture adjacent the inner surface and an upper conduit aperture through which the liquid is dispensed from the container; (c) dispensing means by which the liquid operably enters the conduit means through the lower aperture and is dispensed out of the upper aperture; the improvement wherein the inner surface is so shaped as to define a surface lower portion adapted to cooperate with the conduit lower aperture as to enable, advantageously, substantially all of the liquid to be able to enter the conduit lower aperture operably by the dispensing means. The liquid is, for example, a shampoo, soap, hand lotion, ketchup or similar household product which is dispensed from a hand-held bottle by a hand operated plunger.

### FIELD OF THE INVENTION

This invention relates to a liquid dispenser, such as a bottle or like container for holding a liquid, such as, for example, liquid soap, shampoo, hand cream, lotions and the like, dispensable by pumping action.

### BACKGROUND TO THE INVENTION

Fluid dispensers comprising containers, vessels and the like, such as bottles, barrels, drums, pots, jars, cauldrons, jugs, flasks, canteens, carafes, generally, employ a pump device used to empty the contents of the container. It is common experience, today, that the pump devices employed are unable to completely vacate the contents of most, if not all, of the containers.

Many of the types of containers are disposed of after a single use. Further, such disposable containers containing viscous liquids such as shampoos, creams, lotions, oils, soaps, ketchup and the like liquids, are often discarded still containing considerable residual amounts of the contents representing an unnecessary waste to the consumer. There is, therefore, a need for a liquid dispenser which is more efficacious in the amount of fluid that can be dispensed therefrom than from prior art dispensers.

### SUMMARY OF THE INVENTION

It is an object of the present invention to provide a liquid dispenser which is more efficacious in the amount of liquid contents that can be dispensed therefrom than prior art liquid dispensers. Accordingly, the invention provides a liquid dispenser comprising
(a) a container for holding a dispensable liquid and having
   (i) a base with a base inner surface and
   (ii) an upstanding container side;
(b) inner conduit means having a conduit lower aperture adjacent said inner surface and an upper conduit aperture through which said liquid is dispensed from said container;
(c) dispensing means by which said liquid operably enters said conduit means through said lower aperture and is dispensed out of said upper aperture;
   the improvement wherein said inner surface is so shaped as to define a surface lower portion adapted to cooperate with said conduit lower aperture as to enable substantially all of said liquid to be able to enter said conduit lower aperture operably by said dispensing means.

The dispensing means may be selected from those known in the art, preferably, hand-operated, which dispenses the liquid under pump plunger or like means.

The container may be of any suitable shape, such as, for example, round, oval, square or rectangular.

The conduit means comprises, most preferably, a tube, pipe or the like disposed within the container.

The essence of the invention, as hereindefined, is that the base of the container is of a shape that provides the base inner surface with a minor portion that is lower than the remaining major portion, whereat this minor portion the last residue or dregs of the liquid contents gather, drain, collect and the like and are available to enter the conduit lower aperture to be dispensed in use by the dispensing means. The conduit lower aperture is suitably located at or so adjacent to the minor portion surface that these last dregs of liquid are amenably withdrawn through the aperture into the conduit means.

The conduit means in some embodiments has a portion within the base as to constitute a channel or passage integrally formed with the remainder of the conduit external of the base. Thus, the conduit lower aperture in these embodiments can be deemed to be “integrally adjacent” the surface lower portion.

In alternative embodiments, the tube, pipe or the like may be connected, and, optionally, releasable from the base.

The surface lower portion may be located central or off-center of the base, or adjacent the container side. The base inner surface may, for example, be defined as an inverted symmetrical or non-symmetrical cone, or a symmetrical concave surface having the lowest portion central of the base.

Preferably, the area of the surface lower portion is less than 5%, more preferably less than 2% of the total base inner surface area.

The dispenser according to the invention may be formed of any suitable material, particularly, of a plastics material, such as polyethylene, polypropylene, PET or the like.

### BRIEF DESCRIPTION OF THE DRAWINGS

In order that the invention may be better understood, preferred embodiments will now be described, by way of example only, with reference to the accompanying drawings, wherein

FIGS. 1-6 show diagrammatic cross-sections of various dispensers according to the invention; and wherein the same numerals denote like parts.

### DETAILED DESCRIPTION OF PREFERRED EMBODIMENTS

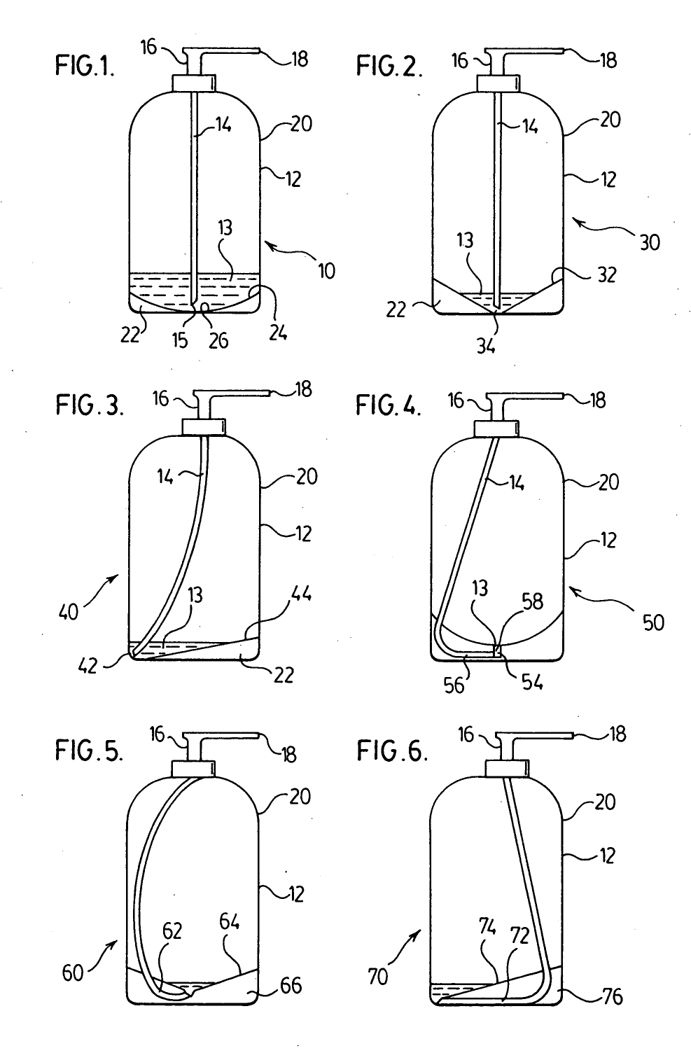

With reference to FIG. 1, this shows generally as 10, a hand-holdable polyethylene dispenser having a container 12 containing hand lotion liquid 13, tube 14 and hand-operated dispensing means comprising plungeable handle 16 and spout 18. Tube 14 has a conduit lower aperture 15 and an upper aperture as spout 18. The inner workings of dispensing means are not shown.

Container 12 has cylindrical side walls 20 and a circular base 22 defining a base inner concave surface 24 having a surface central lower portion 26, which represents about 5% of the base total inner surface area.

In operation, activation of hand plunger 16 effects dispensation of the liquid contents through conduit lower aperture 15, tube 14 and out of spout aperture 18. The liquid is generally intermittently dispensed over a plurality of operating steps over a period of days or weeks.

In prior art dispensers, although, lower aperture 15 is adjacent the base inner surface, the latter is so shaped, generally, flat or convex, as to leave a significant amount, i.e. residue or dregs, of fluid inaccessible for entering through aperture 15 for eventual dispensation out of spout 18. However, in dispenser 10, according to the invention, the dregs gather central of the base surface at portion 26 to allow of enhanced, efficacious removal thereof.

FIG. 2 shows embodiment 30 which is essentially similar to embodiment 10 but wherein base 22 defines an inner conical surface 32 having a central lower surface portion 34 touching or so adjacent aperture 15 as to allow of essentially all contents 13 to be dispensed. In this embodiment, the area of lower surface portion represents less than 2% of the base total surface area.

FIG. 3 shows embodiment 40 which is essentially similar to embodiment 30 of FIG. 2 but having an off-centre surface lower portion 42 produced by base 22 defining an off-centred cone surface 44.

FIG. 4 shows embodiment 50 which is essentially similar to embodiment 10 of FIG. 1 but wherein base 52 is of a greater thickness, and has a central portion defining a receiving well constituting base lower surface portion 54. Base 52 has an inner portion defining conduit or passage 56 which is integrally formed with tube 14 to constitute conduit means having a lower aperture 58 internally adjacent well 54.

FIGS. 5 and 6 show alternative embodiments 60, 70, having similar internal passages or conduits 62, 72, respectively, and inner surfaces 64, 74 defined by their respective bases 66, 76, as embodiments shown in FIGS. 2 and 3.

Although this disclosure has described and illustrated certain preferred embodiments of the invention, it is to be understood that the invention is not restricted to those particular embodiments. Rather, the invention includes all embodiments which are functional or mechanical equivalents of the specific embodiments and features that have been described and illustrated.

1. A liquid dispenser comprising
(a) a container for holding a dispensable liquid and having
(i) a base with a base inner surface and
(ii) an upstanding container side;
(b) inner conduit means having a conduit lower aperture adjacent said inner surface and an upper conduit aperture through which said liquid is dispensed from said container;
(c) dispensing means by which said liquid operably enters said conduit means through said lower aperture and is dispensed out of said upper aperture;
the improvement wherein said inner surface is so shaped as to define a surface lower portion adapted to cooperate with said conduit lower aperture as to enable substantially all of said liquid to be able to enter said conduit lower aperture operably by said dispensing means.

2. A dispenser as defined in claim 1 wherein said surface lower portion is central of said base.

3. A dispenser as defined in claim 1 wherein said surface lower portion is off-center of said base.

4. A dispenser as defined in claim 1 wherein said surface lower portion is adjacent said container side.

5. A dispenser as defined in claim 2 wherein said base inner surface is defined as an inverted symmetrical or non-symmetrical cone.

6. A dispenser as defined in claim 3 wherein said base inner surface is defined as an inverted symmetrical or non-symmetrical cone.

7. A dispenser as defined in claim 4 wherein said base inner surface is defined as an inverted symmetrical or non-symmetrical cone.

8. A dispenser as defined in claim 1 wherein said conduit means comprises a tube.

9. A dispenser as defined in claim 2 wherein said conduit means comprises a tube.

10. A dispenser as defined in claim 3 wherein said conduit means comprises a tube.

11. A dispenser as defined in claim 4 wherein said conduit means comprises a tube.

12. A dispenser as defined in claim 5 wherein said conduit means comprises a tube.

13. A dispenser as defined in claim 1 wherein said base has a portion defining a channel which channel comprises part of said conduit means.

14. A dispenser as defined in claim 13 wherein said channel is integrally formed with said conduit means.

15. A dispenser as defined in claim 8 wherein said tube is connected to said base.

16. A dispenser as defined in claim 15 wherein said tube is releasably connected to said base.

17. A dispenser as defined in claim 1 wherein said inner surface is of a circular, oval, square or rectangular shape.

18. A dispenser as defined in claim 1 wherein said surface lower portion has an area of less than 5% of the surface area of said base inner surface.

19. A dispenser as defined in claim 18 wherein said surface lower area has an area of less than 2% of the surface area of said base inner surface.

20. A dispenser as defined in claim 1 wherein said container is a hand-holdable bottle, said dispensing means comprises a hand-operated pump and said liquid is selected from the group consisting of shampoos, creams, lotions, oils, soaps, ketchup and sauces.
